(19) United States
(12) Patent Application Publication
(10) Pub. No.: US 2025/0139154 A1
(43) Pub. Date: May 1, 2025

(54) ENHANCING DOCUMENT METADATA WITH CONTEXTUAL MOLECULAR INTELLIGENCE

(71) Applicant: MICROSOFT TECHNOLOGY LICENSING, LLC, Redmond, WA (US)

(72) Inventors: Yijian XIANG, Redmond, WA (US); Rohith Venkata PESALA, Redmond, WA (US); Nilgoon ZAREI, Redmond, WA (US); Pramod Kumar SHARMA, Seattle, WA (US); Liang DU, Redmond, WA (US); Robin ABRAHAM, Redmond, WA (US); J Brandon SMOCK, Seattle, WA (US)

(21) Appl. No.: 18/385,873

(22) Filed: Oct. 31, 2023

(51) Int. Cl. G06F 16/53; G06F 16/58; G06N 20/00

(52) U.S. Cl. CPC G06F 16/53; G06F 16/5866; G06N 20/00

(57) ABSTRACT

A molecule representation is extracted from a document and associated with the document in a metadata database. For example, an image of a molecular structure may be extracted from a document and stored in the metadata database in a text-based representation such as SMILES. The metadata database may be searched to identify documents that mention a particular molecule. Continuing the example, the metadata database may be searched with a SMILES representation to identify the document and other documents that refer to the same molecule. The metadata database may index documents based on different types of molecule representations, including text-based, image-based, graph-based, name, abbreviation, etc. This allows search over multiple representations of a molecule, improving accuracy and thoroughness. These improvements reduce the time and computational resources needed to search for documents that refer to a particular molecule.

### BACKGROUND

One of the main tasks of a researcher is to read existing literature. When performing a literature review, researchers often search through a corpus of documents to find relevant information. Once something interesting has been found, such as the name of an enzyme, the researcher may use the name as the basis for continued search. However, current document search systems are limited by the available document metadata. Current types of document metadata may enable text-based search, such as for the name of an enzyme, but do not enable searching for more complex representations of the enzyme. The inability to search for a more complex representation of document content increases the time and computing resources needed to find relevant information.

It is with respect to these and other considerations that the disclosure made herein is presented.

### SUMMARY

A molecule representation is extracted from a document and associated with the document in a metadata database. For example, an image of a molecular structure may be extracted from a document and stored in the metadata database in a text-based representation such as the simplified molecular-input line-entry system (SMILES). The metadata database may be searched to identify documents that mention a particular molecule. Continuing the example, the metadata database may be searched with a SMILES representation to identify the document and other documents that refer to the same molecule. The metadata database may index documents based on different types of molecule representations, including text-based, image-based, graph-based, name, abbreviation, etc. This allows search over multiple representations of a molecule, improving accuracy and thoroughness. These improvements reduce the time and computational resources needed to search for documents that refer to a particular molecule.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates extracting molecule information from a document and storing corresponding molecule data in a metadata database.

FIG. 2 illustrates identifying a molecule referenced in a document and storing molecule metadata in the metadata database.

FIG. 3 illustrates training an image extraction machine learning model.

FIG. 4 illustrates refining the image extraction machine learning model with human feedback.

FIG. 5 illustrates recognizing a molecule and converting it to a text-based representation.

FIG. 6 is a flow diagram of an example method for enhancing document metadata with contextual molecular intelligence.

FIG. 7 is a computer architecture diagram illustrating an illustrative computer hardware and software architecture for a computing system capable of implementing aspects of the techniques and technologies presented herein.

### DETAILED DESCRIPTION

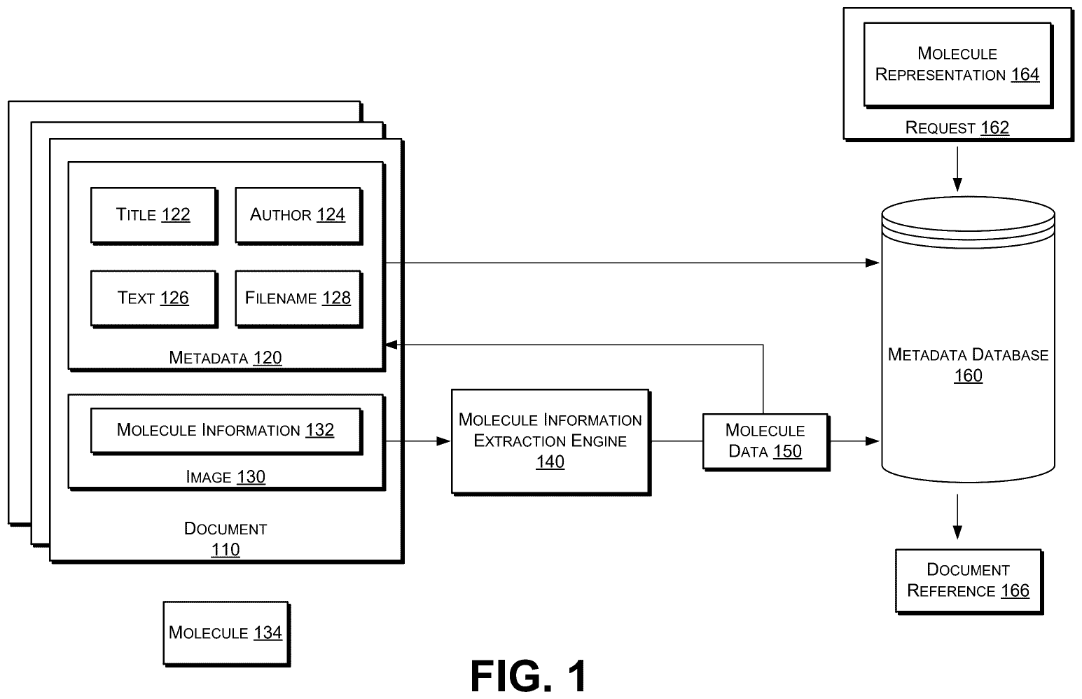

FIG. 1 illustrates extracting molecule information 132 from document 110 and storing molecule information 132 and related molecule data 150 in a metadata database 160. Document 110 contains metadata 120 and image 130. Image 130 is data used to display the contents of document 110. Image 130 may be a bitmap, jpeg, or other raster image format.

Image 130 includes molecule information 132. Molecule information 132 is an image, text, or other depiction of molecule 134. For example, molecule information 132 may be a graphical image of the structure of molecule 134. Additionally, or alternatively, molecule information 132 may be a text-based representation, such as a SMILES, of molecule 134. Molecule information 132 may also refer to a name or abbreviation of a molecule, such as “Azidothymidine”, an antiretroviral with the abbreviation AZT. Molecule 134 may represent any chemical molecule, biological molecule, or other arrangement of atoms bonded together.

Metadata 120 may include text, images, markup, icons, or any other type of data associated with document 110. For example, title 122 indicates the title of document 110, author 124 indicates the author of document 110, text 126 includes the full or partial text of document 110, and filename 128 indicates the name of the file document 110 is stored in. These examples of metadata 120 are non-limiting, and other types of metadata are similarly contemplated. These and other types of metadata 120 may be used to index document 110, search for document 110, and/or draw associations with other documents. Example, author 124 may be used to associate document 110 with other documents having the same author. Text 126 may be used to perform full text searches of document 110.

In some configurations, molecule information extraction engine 140 extracts molecule information 132, often as an image, and uses it to obtain molecule data 150. While described below in more detail, molecule information extraction engine 140 may utilize machine learning models to isolate molecule information 132 from surrounding document content. Molecule information extraction engine 140 may then utilize machine learning models to generate a graph-based representation of molecule 134, which may be converted to a text-based representation. One suitable example of a technique for generating a graph-based representation from an image of a molecule is provided in U.S. Pat. App. Pub. No. US2023/0196179. Molecule information extraction engine 140 may use one or more of the representations of molecule 134 to obtain molecule data 150.

In some configurations, molecule data 150 is stored in metadata database 160. Metadata database 160 indexes document 110 using molecule data 150, allowing search requests to find multiple documents that refer to a particular molecule. Metadata database 160 may be a relational database, a key/value pair database, a vector database, or any other type of data storage application. As illustrated, search request 162 contains molecule representation 164, which may be a graphical representation, a text-based representation, a name, an abbreviation, or the like. Metadata database 160 may respond to request 162 with one or more document references 166, which describe and/or link to documents associated with molecule representation 164. Additionally, or alternatively, molecule data 150 may be stored in metadata 120 of document 110, enabling enhanced search and indexing scenarios without metadata database 160.

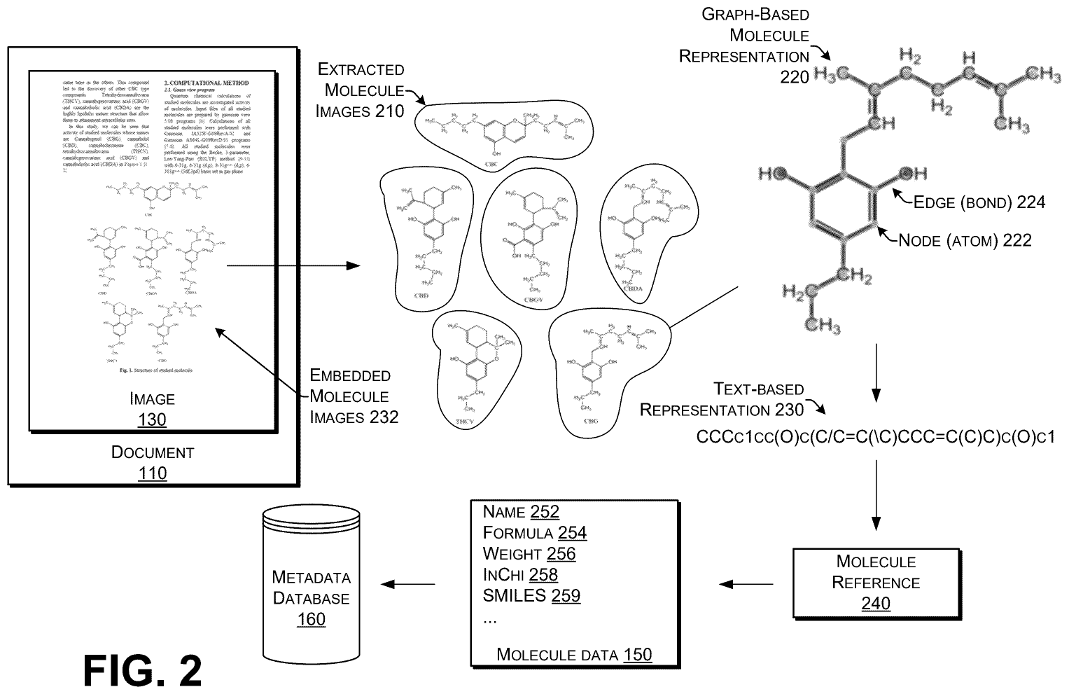

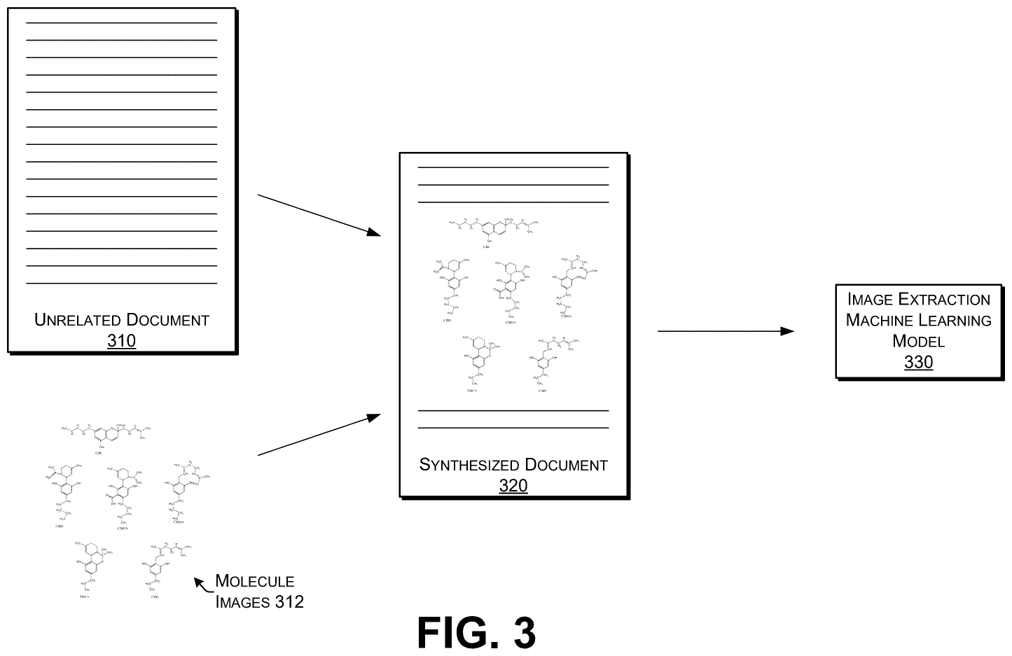

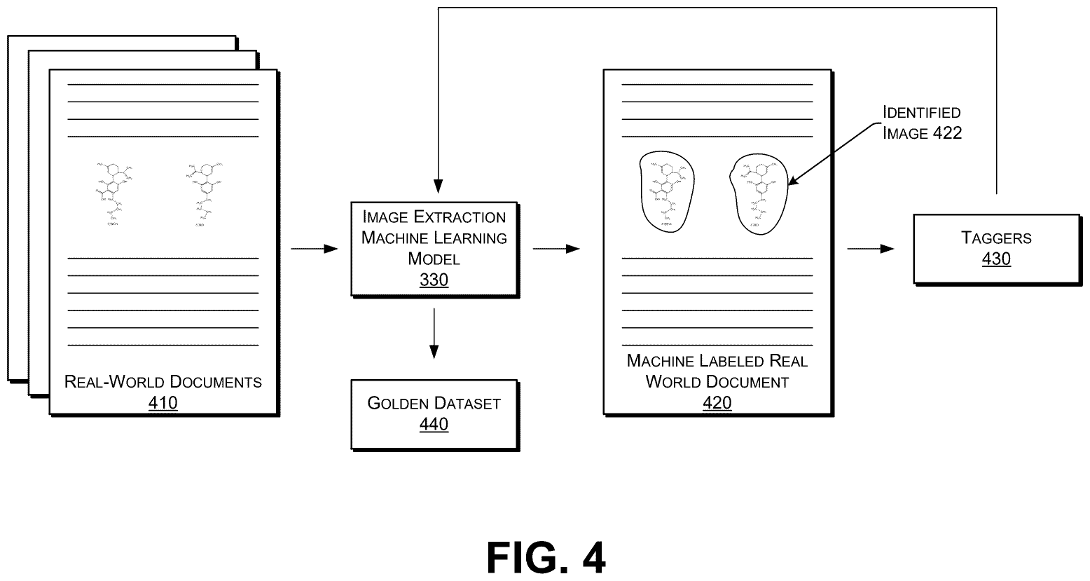

FIG. 2 illustrates identifying a molecule referenced in document 110 and storing molecule metadata 150 of that molecule in metadata database 160. As illustrated, image 130 of document 110 contains embedded molecule images 232. In order to identify the depicted molecules, molecule information extraction engine 140 segments image 130 as discussed below in conjunction with FIGS. 3 and 4.

The resulting extracted molecule images 210 may be analyzed to generate graph-based molecule representation 220, including nodes (atoms) 222 and edges (bonds) 224. In some configurations, a machine learning model is used to predict the locations of nodes (atoms) 222 and the edges (bonds) 224 that connect them. These nodes 222 and edges 224 may be used by a chemistry-aware algorithm to generate graph-based molecule representation 220.

Molecule information extraction engine 140 may also convert extracted molecule images 210 into text-based representation 230. As illustrated, text-based representation 230 is a SMILES, but other text-based representations such as an International Chemical Identifier (InChI) are similarly contemplated. Text-based representation 230 may be derived from graph-based molecule representation 220 or directly from extracted molecule image 210.

Molecule information extraction engine 140 may then provide one or more representations of molecule 134 to molecule reference 240 to obtain molecule metadata 150 for extracted molecule 210. Molecule reference 240 may be a publicly available website or database that provides properties of molecule 134 used to generate molecule data 150, such as PubChem. Molecule reference 240 may also be a locally hosted database. As illustrated, molecule data 150 includes name 252, formula 254, weight 256, InChI 258, and SMILES 259 although more, fewer, or different properties of molecule 134 are similarly contemplated. Molecule data 150 may also include, for example, extracted molecule image 210, or an image of molecule 134 obtained from molecule reference 240. In some configurations, molecule data 150 includes an indication of which page of document 110 the corresponding extracted molecule image 210 came from.

Molecule information extraction engine 140 may then store molecule data 150 in metadata database 160. Molecule data 150 may be stored directly in metadata database 160 or by reference to an external storage location. Molecule data 150 may also be embedded in metadata 120 of document 110.

FIG. 3 illustrates training image extraction machine learning model 330. Image extraction machine learning model 330 is used by molecule information extraction engine 140 to isolate representations of molecule 134 in document 110. Image extraction machine learning model 330 may be any type of machine learning model, such as an image segmentation machine learning model. For example, image extraction machine learning model 330 may be a Mask Region-Based Convolutional Neural Networks (R-CNN) model.

Image extraction machine learning model 330 may be initially trained on a corpus of synthesized documents 320. Synthesized documents 320 may be constructed from unrelated documents 310 that are modified by adding molecule images 312. In some configurations, documents 310 are “unrelated” in that the text they contain is not necessarily related to the molecule images 312 that are added to them. Additionally, or alternatively, documents 310 are unrelated in that they do not contain molecules, and are typically obtained from a different knowledge domain. For example, molecule images 312 may be overlaid on top of, or made to displace text of unrelated documents 310, to create synthesized documents 320. Molecule images 312 are similar to extracted molecule images 210 except they are known to be images of molecules of the kind that will be encountered in document 110. When training image extraction machine learning model 330, a loss function may compute whether an image extracted from synthesized document 320 is in fact one of molecule images 312.

FIG. 4 illustrates refining the image extraction machine learning model 330 with human feedback. In some configurations, real-world documents 410, which may or may not include image representations of molecules, are provided to image extraction machine learning model 330. Image extraction machine learning model 330 may label images, such as identified image 422 of machine labeled real world document 420. Human taggers 430 may indicate whether identified image 422 was correctly or incorrectly labeled by image extraction machine learning model 330, and manually correct the labels as needed. Feedback and corrected labels from taggers 430 may be used to compute a loss function while refining image extraction machine learning model 330. In some configurations, a golden dataset 440 is used to confirm the accuracy of image extraction machine learning model 330. Training may continue until a minimum correctness threshold of golden dataset 440 is reached.

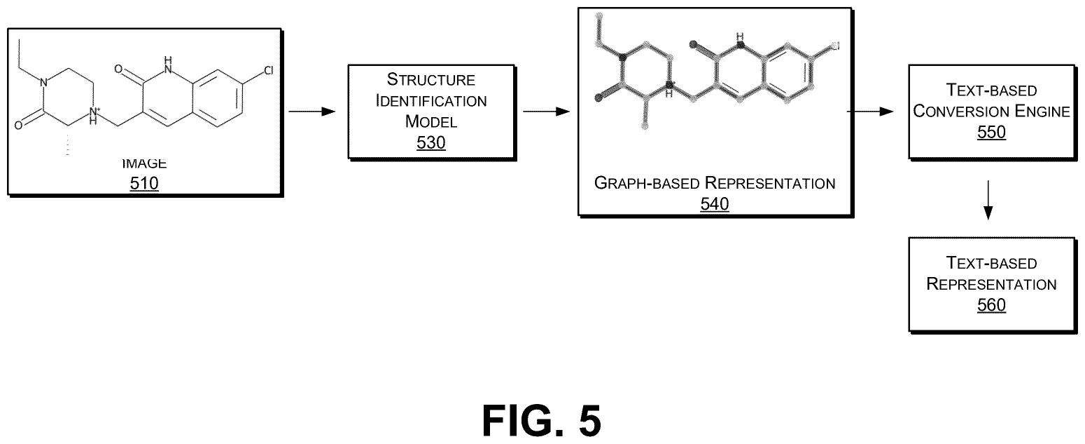

FIG. 5 illustrates recognizing molecule 134 and converting it to text-based representation 560. Image 510 was generated by applying image extraction machine learning model 330 to image 130 of document 110.

Structure identification model 530 is a machine learning model trained to predict a graph-based representation of molecule 134 from image 510. Structure identification model 530 may accept image 510 as input and output predictions of the locations of atoms and bonds of molecule 134. Structure identification model 530 may also predict properties of an atom such as how many hydrogens that atom has, what kind of atom it is, whether there is an ionization on the atom, etc. Similarly for bonds, structure identification model 530 predicts the existence of bonds and whether it is a single bond, a double bond, etc. Structure identification model 530 may also predict the chirality of a bond. Structure identification model 530 may provide confidence scores for each of these predictions. In some configurations, structure identification model 530 has a transformer-based architecture.

The predictions generated by structure identification model 530 may be encoded as graph-based representation 540. Graph-based representation 540 may represent atoms of molecule 134 as nodes 222 and bonds between atoms as edges 224. In some configurations, the predictions of atoms and bonds of molecule 134 are provided to an existing cheminformatics toolkit such as, but not limited to, RDKit that generates another graph-based representation 540 that may be indexed by metadata database 160 or embedded with metadata 120 of document 110.

Text-based conversion engine 550 may generate text-based representation 560 of molecule 134 from graph-based representation 540. In some configurations, text-based conversion engine uses a toolkit such as RDKit to infer a SMILES or other text-based representation 560 from graph-based representation 540.

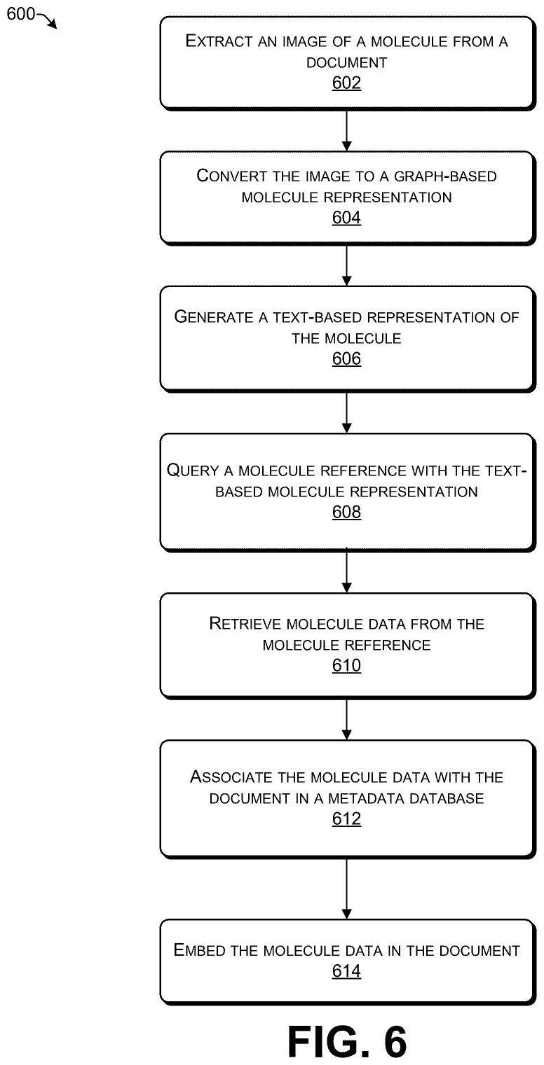

FIG. 6 is a flow diagram of an example method for enhancing document metadata with contextual molecular intelligence. Routine 600 begins at operation 602, where image 130 of molecule 134 is extracted from document 110A. Image 130 may be extracted using image extraction machine learning model 330, which may be trained with synthesized documents and refined with human feedback.

Next at operation 604, image 130 is converted to graph-based molecule representation 540 using structure identification model 530. In some configurations structure identification model 530 is a transformer-based model trained to predict the location of the atoms of molecule 134 and the bonds between them.

Next at operation 606, text-based conversion engine 550 converts graph-based molecule representation 540 to text-based representation 560. SMILES is a non-limiting example of text-based representation 560—other text-based molecular representations are similarly contemplated.

Next at operation 608, molecule reference 240 is queried with text-based representation 560. Molecule reference 240 may be a publicly available website or database that provides molecule data 150.

Next, at operation 610, molecule data 150 is retrieved from molecule reference 240. Molecule data 150 may include name 252, molecular formula 254, molecular weight 256, InChI 258, SMILES 259, and other properties.

Next, at operation 612, molecule data 150 is associated with document 110 in metadata database 160. In some configurations, an entry in metadata database 160 for document 110 includes one or more molecule representations of molecule 134, such as graph-based representation 540 and text-based representation 560. Indexing document 110 by various representations of molecule 134 associates document 110 with other documents that reference the same molecule 134, enabling a researcher to quickly view other documents that refer to the same molecule.

Next, at operation 614, molecule data 150 is embedded into metadata 120 of document 110. In some configurations, molecule data 150 is obtained from metadata database 160 for embedding into metadata 120.

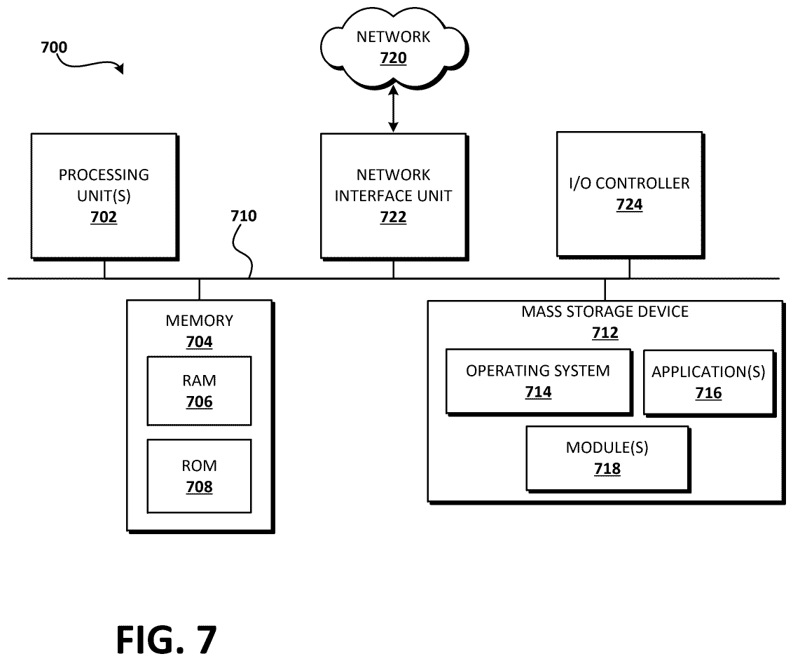

FIG. 7 shows additional details of an example computer architecture 700 for a device, such as a computer or a server configured as part of the systems described herein, capable of executing computer instructions (e.g., a module or a program component described herein). The computer architecture 700 illustrated in FIG. 7 includes processing unit(s) 702, a system memory 704, including a random-access memory 706 (“RAM”) and a read-only memory (“ROM”) 708, and a system bus 710 that couples the memory 704 to the processing unit(s) 702. The processing unit(s) 702 include one or more hardware processors and may also comprise or be part of a processing system. In various examples, the processing unit(s) 702 of the processing system are distributed. Stated another way, one processing unit 702 may be located in a first location (e.g., a rack within a datacenter) while another processing unit 702 of the processing system is located in a second location separate from the first location.

Processing unit(s), such as processing unit(s) 702, can represent, for example, a CPU-type processing unit, a GPU-type processing unit, a neural processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 700, such as during startup, is stored in the ROM 708. The computer architecture 700 further includes a mass storage device 712 for storing an operating system 714, application(s) 716, modules 718, and other data described herein.

The mass storage device 712 is connected to processing unit(s) 702 through a mass storage controller connected to the bus 710. The mass storage device 712 and its associated computer-readable media provide non-volatile storage for the computer architecture 700. Although the description of computer-readable media contained herein refers to a mass storage device, it should be appreciated by those tooled in the art that computer-readable media can be any available computer-readable storage media or communication media that can be accessed by the computer architecture 700.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 700 may operate in a networked environment using logical connections to remote computers through the network 720. The computer architecture 700 may connect to the network 720 through a network interface unit 722 connected to the bus 710. The computer architecture 700 also may include an input/output controller 724 for receiving and processing input from a number of other devices, including a keyboard, mouse, touch, or electronic stylus or pen. Similarly, the input/output controller 724 may provide output to a display screen, a printer, or other type of output device.

It should be appreciated that the software components described herein may, when loaded into the processing unit(s) 702 and executed, transform the processing unit(s) 702 and the overall computer architecture 700 from a general-purpose computing system into a special-purpose computing system customized to facilitate the functionality presented herein. The processing unit(s) 702 may be constructed from any number of transistors or other discrete circuit elements, which may individually or collectively assume any number of states. More specifically, the processing unit(s) 702 may operate as a finite-state machine, in response to executable instructions contained within the software modules disclosed herein. These computer-executable instructions may transform the processing unit(s) 702 by specifying how the processing unit(s) 702 transition between states, thereby transforming the transistors or other discrete hardware elements constituting the processing unit(s) 702.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

### Illustrative Embodiments

The following clauses describe multiple possible embodiments for implementing the features described in this disclosure. The various embodiments described herein are not limiting nor is every feature from any given embodiment required to be present in another embodiment. Any two or more of the embodiments may be combined together unless context clearly indicates otherwise. As used herein in this document “or” means and/or. For example, “A or B” means A without B, B without A, or A and B. As used herein, “comprising” means including all listed features and potentially including addition of other features that are not listed. “Consisting essentially of” means including the listed features and those additional features that do not materially affect the basic and novel characteristics of the listed features. “Consisting of” means only the listed features to the exclusion of any feature not listed.

Example 1: A method comprising: extracting an image of a molecule from a document; converting the image to a molecule representation; querying a molecule reference with the molecule representation; retrieving molecule data from the molecule reference; and associating the document with the molecule data.

Example 2: The method of Example 1, further comprising: receiving a query that includes a representation of the molecule; identifying another document that contains an individual representation of the molecule; and providing a link to the other document.

Example 3: The method of Example 1, wherein the image of the molecule is extracted from the document using an image extraction machine learning model trained on synthetic documents, and wherein the synthetic documents are created by inserting images of molecules into text documents.

Example 4: The method of Example 3, wherein the image extraction machine learning model is refined by manually tagging images of molecules identified in real world documents by the image extraction machine learning model.

Example 5: The method of Example 1, further comprising: embedding the molecule data into the document.

Example 6: The method of Example 1, wherein converting the image to the molecule representation comprises: providing the image to a structure identification machine learning model.

Example 7: The method of Example 6, wherein the structure identification machine learning model predicts a location of an atom in the molecule and one or more bonds between atoms of the molecule, and wherein the molecule information is generated from the predicted atom location and the predicted one or more bonds.

Example 8: A system comprising: a processing unit; and a computer-readable storage medium having computer-executable instructions stored thereupon, which, when executed by the processing unit, cause the processing unit to: extract an image of a molecule from a document; convert the image to a molecule representation; query a molecule reference with the molecule representation; retrieve molecule data from the molecule reference; and embed the molecule data in the document.

Example 9: The system of Example 8, wherein the molecule data comprises a graphic representation of the molecule obtained from the molecule reference.

Example 10: The system of Example 8, wherein the molecule data is displayed in a user interface of an application that displays the document.

Example 11: The system of Example 8, wherein the image of the molecule is extracted from the document using an image extraction machine learning model.

Example 12: The system of Example 8, wherein converting the image to the molecule representation comprises: providing the image to a structure identification machine learning model.

Example 13: The system of Example 8, wherein the molecule data comprises a name, a molecular formula, or a molecular weight.

Example 14: The system of Example 8, wherein the molecule data is embedded with a page number of the image.

Example 15: The system of Example 8, wherein the molecule representation comprises a text-based representation.

Example 16: A computer-readable storage medium having encoded thereon computer-readable instructions that when executed by a processing unit cause a system to: extract an image of a molecule from a document; convert the image to a molecule representation; query a molecule reference with the molecule representation; retrieve molecule data from the molecule reference; store an association of the document and the molecule data in a metadata database; and in response to a request that includes an individual molecule representation of the molecule, returning a reference to the document.

Example 17: The computer-readable storage medium of Example 16, wherein the molecule representation comprises a text-based representation of the molecule.

Example 18: The computer-readable storage medium of Example 17, wherein the molecule representation comprises a Simplified Molecular Input Line Entry System (SMILES).

Example 19: The computer-readable storage medium of Example 16, wherein the individual molecule representation was embedded in another document, and wherein the other document includes another image of the molecule.

Example 20: The computer-readable storage medium of Example 16, wherein the individual molecule representation was listed in a search result received from the metadata database.

### CONCLUSION

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

The terms “a,” “an,” “the” and similar referents used in the context of describing the invention are to be construed to cover both the singular and the plural unless otherwise indicated herein or clearly contradicted by context. The terms “based on,” “based upon,” and similar referents are to be construed as meaning “based at least in part” which includes being “based in part” and “based in whole,” unless otherwise indicated or clearly contradicted by context. The terms “portion,” “part,” or similar referents are to be construed as meaning at least a portion or part of the whole including up to the entire noun referenced.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Furthermore, references have been made to publications, patents and/or patent applications throughout this specification. Each of the cited references is individually incorporated herein by reference for its particular cited teachings as well as for all that it discloses.

What is claimed is:

1. A method comprising:
extracting an image of a molecule from a document;
converting the image to a molecule representation;
querying a molecule reference with the molecule representation;
retrieving molecule data from the molecule reference; and
associating the document with the molecule data.

2. The method of claim 1, further comprising:
receiving a query that includes a representation of the molecule;
identifying another document that contains an individual representation of the molecule; and
providing a link to the other document.

3. The method of claim 1, wherein the image of the molecule is extracted from the document using an image extraction machine learning model trained on synthetic documents, and wherein the synthetic documents are created by inserting images of molecules into text documents.

4. The method of claim 3, wherein the image extraction machine learning model is refined by manually tagging images of molecules identified in real world documents by the image extraction machine learning model.

5. The method of claim 1, further comprising:
embedding the molecule data into the document.

6. The method of claim 1, wherein converting the image to the molecule representation comprises:
providing the image to a structure identification machine learning model.

7. The method of claim 6, wherein the structure identification machine learning model predicts a location of an atom in the molecule and one or more bonds between atoms of the molecule, and wherein the molecule information is generated from the predicted atom location and the predicted one or more bonds.

8. A system comprising:
a processing unit; and
a computer-readable storage medium having computer-executable instructions stored thereupon, which, when executed by the processing unit, cause the processing unit to:
extract an image of a molecule from a document;
convert the image to a molecule representation;
query a molecule reference with the molecule representation;
retrieve molecule data from the molecule reference; and
embed the molecule data in the document.

9. The system of claim 8, wherein the molecule data comprises a graphic representation of the molecule obtained from the molecule reference.

10. The system of claim 8, wherein the molecule data is displayed in a user interface of an application that displays the document.

11. The system of claim 8, wherein the image of the molecule is extracted from the document using an image extraction machine learning model.

12. The system of claim 8, wherein converting the image to the molecule representation comprises:
providing the image to a structure identification machine learning model.

13. The system of claim 8, wherein the molecule data comprises a name, a molecular formula, or a molecular weight.

14. The system of claim 8, wherein the molecule data is embedded with a page number of the image.

15. The system of claim 8, wherein the molecule representation comprises a text-based representation.

16. A computer-readable storage medium having encoded thereon computer-readable instructions that when executed by a processing unit cause a system to:
extract an image of a molecule from a document;
convert the image to a molecule representation;
query a molecule reference with the molecule representation;
retrieve molecule data from the molecule reference;
store an association of the document and the molecule data in a metadata database; and
in response to a request that includes an individual molecule representation of the molecule, returning a reference to the document.

17. The computer-readable storage medium of claim 16, wherein the molecule representation comprises a text-based representation of the molecule.

18. The computer-readable storage medium of claim 17, wherein the molecule representation comprises a Simplified Molecular Input Line Entry System (SMILES).

19. The computer-readable storage medium of claim 16, wherein the individual molecule representation was embedded in another document, and wherein the other document includes another image of the molecule.

20. The computer-readable storage medium of claim 16, wherein the individual molecule representation was listed in a search result received from the metadata database.
